(19) United States
(12) Patent Application Publication
(10) Pub. No.: US 2009/0193421 A1
(43) Pub. Date: Jul. 30, 2009

(54) Method For Determining The Impact Of Resource Consumption Of Batch Jobs Within A Target Processing Environment

(75) Inventors: Fabio Benedetti, Rome (IT); Umberto Caselli, Rome (IT); Paolo Deidda, Rome (IT)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/022,775

(22) Filed: Jan. 30, 2008

(51) Int. Cl. G06F 9/46

(52) U.S. Cl. 718/101

(57) ABSTRACT

Exemplary embodiments of the present invention provide a solution that comprises the capability to dispatch jobs to target system according to the declared resource consumption by providing a way for automatically calculating the resource consumption at a target processing system. The algorithmic solution provided can also be utilized by standalone reporting tools to calculate resource consumption offline and show resource impact based upon database query results in the event that data samples are available. The solution provided by exemplary embodiments of the present invention is obtained by reducing the resource consumption problem to an optimization problem involving a set of linear equations.

### BACKGROUND OF THE INVENTION

1. Field of the Invention

This invention relates to resource consumption management, and particularly to determining the impact of resource consumption within a processing environment.

2. Description of Background

When batch jobs are scheduled on a target processing system, it is difficult to determine the impact of the job on the consumption of resources at the target processing system. Within a small subset of applications this is an easy task (e.g., when a process—or a set of processes—is generated) in the instance that a set of processes that are spawned by the applications do not create any perturbation within a system. In a client/server environment, where a job utilizes services provided by other processes, or when a process is adding load to a different process as a side effect of its operational capacity (e.g., an antivirus application, a log analyzer, etc.) it may be very hard to determine what load is added to a system from a particular job. These particular issues prevent job brokers from calculating repetitive jobs resource consumptions in order to better dispatch the jobs to the target computer system according to actual resource availability.

### SUMMARY OF THE INVENTION

The shortcomings of the prior art are overcome and additional advantages are provided through the provision of a method for determining the impact of resource consumption of batch jobs at a target processing environment. The method comprises sampling the total usage of any resource and determining resource usage that is related to the batch job executing at the target processing environment, wherein the resource usage that is related to a batch job is represented by Jₗ(t) by knowing the start and end time of each batch job. The method also comprises determining resource usage that is related to processes that are not associated with any batch jobs that are executing at a target processing environment, wherein the resource usage that is related to processes that are not associated with any batch jobs is represented by N(tᵢ), and sampling total resource usage R(tᵢ) at a target processing environment, wherein the total resource usage is R(tᵢ)=N(tᵢ) in the instance that there are no batch jobs executing at the target processing environment and R(tᵢ)=Jₗ(t)+N(tᵢ) for each instance of a batch job that is executed at the target processing environment.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1A is a graph illustrating the tracking of resource usage that is associated with a single executing batch job.

FIG. 1B is a graph illustrating the approximated output for resource usage that is associated with a single executing batch job.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art.

Exemplary embodiments of the present invention provide a solution that comprises the capability to dispatch jobs to target system according to the declared resource consumption by providing a way for automatically calculating the resource consumption at a target processing system. The algorithmic solution provided can be utilized by standalone reporting tools to calculate resource consumption offline and show resource impact based upon database query results in the event that data samples are available. Within further exemplary embodiments the algorithmic solution can be used online for the calculating of resource consumption and determining of resource impact on a set of jobs that are executed within a real-time production environment.

The solution provided by exemplary embodiments of the present invention is obtained by reducing the resource consumption problem to an optimization problem involving a set of linear equations. By utilizing resource measurement samples with fine granularity the resource consumption problem can be solved by using a pseudo-inverse matrix technique wherein the approximations obtained via the technique are as close to the actual values as determined by the monitored frequency of resource consumption usage samples.

Within exemplary embodiments of the present it is assumed that the usage of a resource can be directly linked to a specific job and the time period required for the performance of the job (i.e., because the resource is utilized by the process tree that is spawned by the job) and that the segment of resource does not belong to any jobs is also known. As such, the usage of a resource can always be directly linked to a process; however, it is not always so easy to ascertain how a resource is linked to a process. It cannot be assumed that the resources that are utilized by a process belonging to a job are the only resources that are linked to that specific job.

For each sampling period the following equation applies:

R(tᵢ)=ΣJⱼ(tᵢ)+N(tᵢ) Equation 1

Equation 2 can be utilized to determine an approximation of the impact of a single job on a target processing system, wherein the total resource usage can be calculated by:

R(t)=Jₗ(t)+N(t) Equation 2

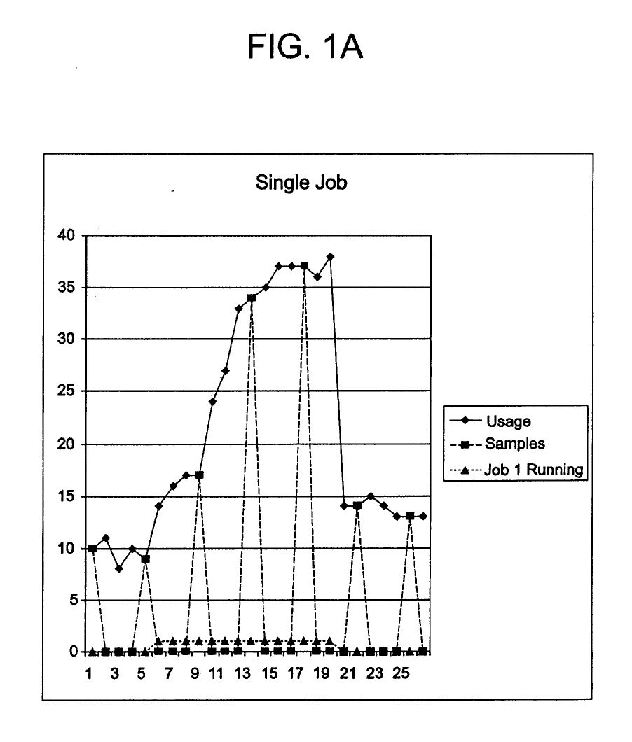

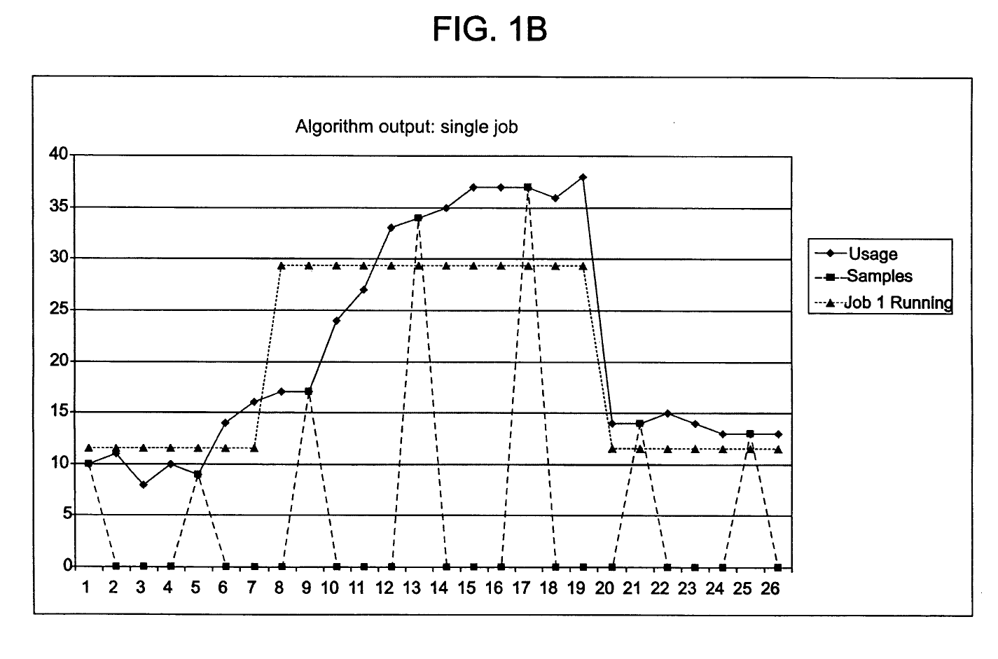

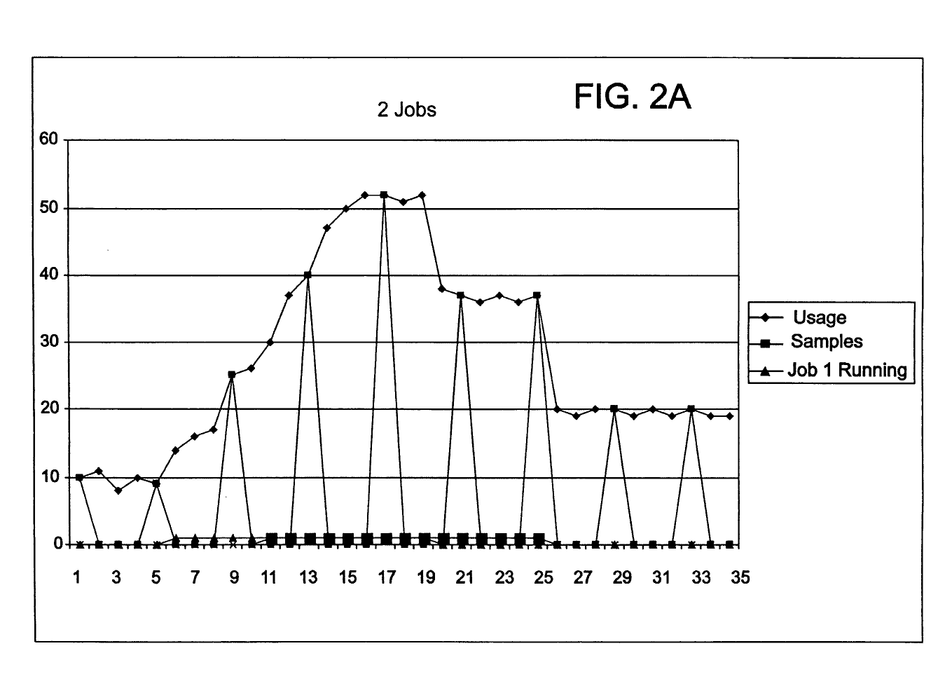

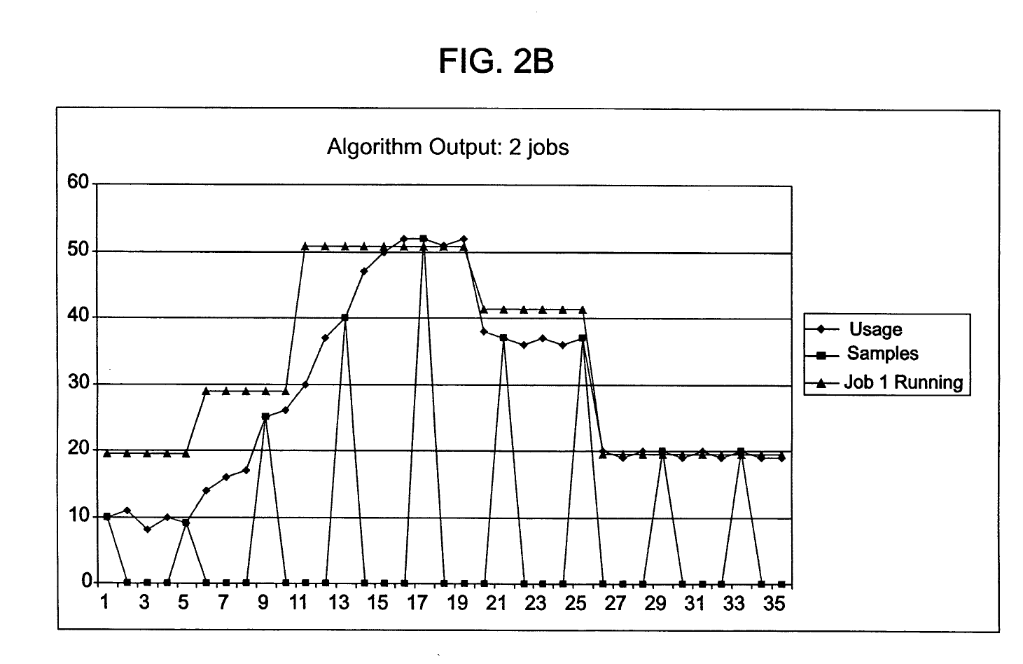

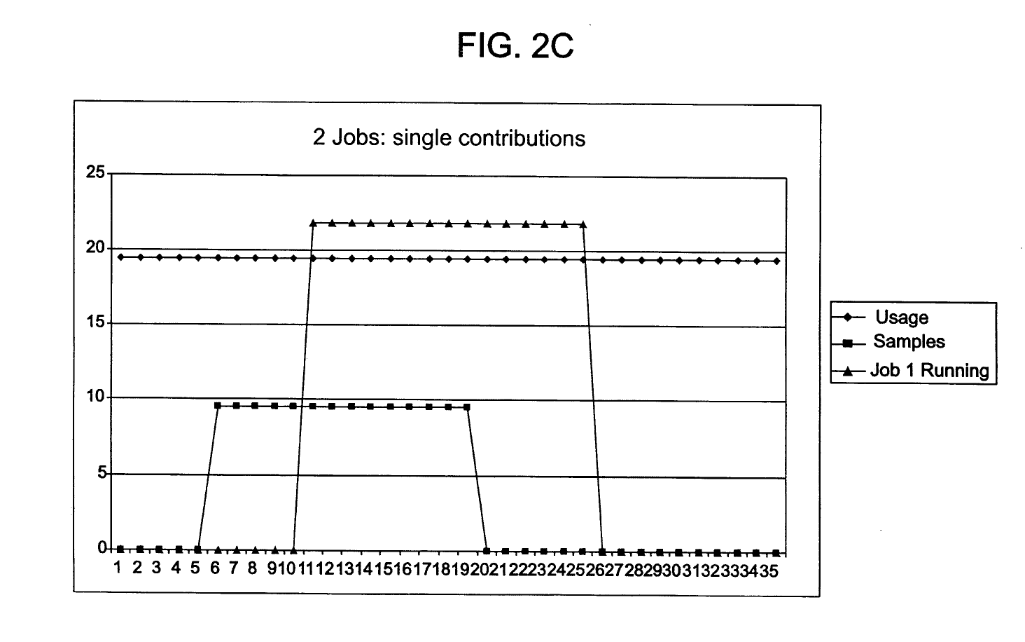

FIG. 1A shows a graph wherein the usage of target processing resource with a single executing job. By taking a sample of the values of the resource we obtain the following set of equations:

if a single job is running, then:

R(tᵢ)=Jₗ(tᵢ)+N(tᵢ) Equation 3

if a single job is not running

R(tᵢ)=N(tᵢ) Equation 4

### Where:

R(t) is the total usage of the resource
Jₗ(t) is the resource usage related to a single processing job
N(t) is the resource usage that is related to processes that do not belong to any job

Thus, for the graph of FIG. 1 we obtain the following equations:

TABLE 1

R(0) = N(0) = 10
R(4) = N(4) = 9
R(8) = J₁(8) + N(8) = 17
R(12) = J₁(12) + N(12) = 34
R(16) = J₁(16) + N(16) = 37
R(20) = N(20) = 14
R(24) = N(24) = 13

Let us assume the resource usage related to a single job can be approximated with a constant value:

Jₗ(tᵢ)≈Jᵢ(tⱼ)≈Jᵢ Equation 5

N(tᵢ)≈N(tⱼ)≈N Equation 6

The equations above are changed like this:

TABLE 2

R(0) = N = 10
R(4) = N = 9
R(8) = J₁ + N = 17
R(12) = J₁ + N = 34
R(16) = J₁ + N = 37
R(20) = N = 14
R(24) = N = 13

It is easy to understand that the system above does not have solutions, but what are the values of N and J that are closest to the solution? We can define the equation system above as a product of a matrix and a vector:

TABLE 3
$A \cdot x = b = ( \begin{matrix}0 & 1 \\ 0 & 1 \\ 1 & 1 \\ 1 & 1 \\ 1 & 1 \\ 0 & 1 \\ 0 & 1\end{matrix} ) * ( \begin{matrix}J \\ N\end{matrix} ) = ( \begin{matrix}10 \\ 9 \\ 17 \\ 34 \\ 37 \\ 14 \\ 13\end{matrix} )$

This is an over determined system and the matrix does not have an inverse. It has indeed a pseudo-inverse that is finding the values for J and N that minimize the distance to the solution. The pseudo-inverse matrix looks like this:

$${A}^{T} = ( \begin{matrix}- 0.25 & - 0.25 & 0.33 & 0.33 & 0.33 & - 0.25 & - 0.25 \\ 0.25 & 0.25 & 0 & 0 & 0 & 0.25 & 0.25\end{matrix} )$$

and so:

$$x = {A}^{T} \cdot A = {A}^{T} \cdot b = ( \begin{matrix}17.83 \\ 11.5\end{matrix} )$$

Putting these values in the graph, the results are illustrated in FIG. 1B. Within exemplary embodiments of the present invention it is assumed that the rank of the matrix must be maximum (we need a number of linear independent equations that is greater than the number of jobs+1).

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. (canceled)

2. A computer program product that includes a computer readable medium useable by a processor, the medium having stored thereon a sequence of instructions which, when executed by the processor, causes the processor to determine the impact of resource consumption of batch jobs at a target processing environment by:
identifying a set of batch jobs executing at a target processing environment for analysis;
determining resource usage that is related to each batch job executing at the target processing environment, wherein the resource usage that is related to a batch job, J₁, is represented by J₁(t), where t is the time required to complete the batch job;
identifying a time period for the initiation and ending of the batch job;
determining resource usage that is related to processes, Nₙ, where n is the number of processes, that are not associated with any batch jobs that are executing at a target processing environment, wherein the resource usage that is related to processes that are not associated with any batch jobs is represented by Nₙ(tᵢ), where tᵢ is the time required to complete the processes;
sampling total resource Rₜ usage Rₜ(tᵢ), where tᵢ is the time required to complete the processes, at a target processing environment, wherein the total resource usage is Rₜ(tᵢ)=Nₙ(tᵢ) in the instance that there are no batch jobs executing at the target processing environment and Rₜ(tᵢ)=the resource usage sum of each batch job executed at the target processing environment, J₁₋ₙ(t), where n is the number of batch jobs executed at the target processing environment, and a value of Nₙ(tᵢ); and
dispatching further batch jobs and/or processes to the target processing environment in accordance with the sampling of the Rₜ(tᵢ).
